(19) United States
(12) Patent Application Publication
(10) Pub. No.: US 2019/0361124 A1
(43) Pub. Date: Nov. 28, 2019

(54) DISPLACEMENT MEASUREMENT DEVICE AND DISPLACEMENT MEASUREMENT METHOD

(71) Applicant: NuFlare Technology, Inc., Yokohama-shi (JP)

(72) Inventors: Riki OGAWA, Kawasaki-shi (JP); Hiroyuki NAGAHAMA, Niiza-shi (JP); Michiyo SAITO, Kawaguchi-shi (JP)

(73) Assignee: NuFlare Technology, Inc., Yokohama-shi (JP)

(21) Appl. No.: 16/418,022

(22) Filed: May 21, 2019

(30) Foreign Application Priority Data
May 22, 2018 (JP) 2018-098296

(51) Int. Cl. G01S 17/58; G01S 7/48; G01S 7/481

(52) U.S. Cl. CPC G01S 17/58; G01S 7/4811; G01S 7/4808

(57) ABSTRACT

According to one aspect of the present invention, a displacement measurement device includes a control circuit controlling an optical path movement mechanism so that a first total sum of a plurality of intensity signals output from a first position detection sensor and a second total sum of a plurality of intensity signals output from a second position detection sensor change at the same time in a case in which a first and second lights and a stage are relatively moved to cross a boundary; and a displacement measurement circuit calculating an average value of first displacement of a object surface based on the plurality of intensity signals output from the first position detection sensor and second displacement of the object surface based on the plurality of intensity signals output from the second position detection sensor to measure the average value as the displacement of the object surface.

### CROSS-REFERENCE TO RELATED APPLICATION

This application is based upon and claims the benefit of priority from prior Japanese Patent Application No. 2018-098296 filed on May 22, 2018 in Japan, the entire contents of which are incorporated herein by reference.

### BACKGROUND OF THE INVENTION

### Field of the Invention

The embodiments relate to a displacement measurement device and a displacement measurement method. For example, the embodiments relate to a method of measuring height displacement of an object surface by an optical lever principle.

### Related Art

When height displacement of a substrate provided with patterns is measured by an optical lever type displacement meter, a center of a measurement beam is shifted due to an influence of a difference in reflectance between the patterns (dark and bright portions) and hence a problem arises in that an erroneous recognition is made as if a change in height occurs. For this reason, it is difficult to improve the accuracy of the height displacement measurement of the substrate provided with the patterns.

For such a problem, there is proposed a method in which two sets of optical lever type displacement meters are prepared, an optical system is disposed so that two beams travel in the same optical path in the opposite direction, height displacement of the same measurement position is measured, and a total value of obtained measurement values is used as a true measurement value (as disclosed for example in JP-A-08-021705).

However, in order to measure the same optical path from the opposite direction, two beam spot positions need to perfectly match each other. When there is a difference between two beam spot positions, it is difficult to eliminate an influence of a difference in reflectance even when the measurement values are combined. Also in the document that discloses a method in which two sets of optical lever type displacement meters are prepared, since a measurement is performed a plurality of times while rotating the substrate about a measurement position using one set of optical lever type displacement meters and the measurement results are combined, it is difficult to allow two beam spot positions to match each other.

### BRIEF SUMMARY OF THE INVENTION

According to one aspect of the present invention, a displacement measurement device includes:

a movable stage having an object of a measurement target disposed thereon;

a first light source generating first light incident from an oblique direction to an object surface;

a first position detection sensor receiving first reflected light of the first light reflected by the object surface and detecting a position of the first reflected light;

a second light source generating second light incident from an oblique direction to the object surface so that the second light travels in an optical path of the first reflected light in the opposite direction;

a second position detection sensor receiving second reflected light of the second light reflected by the object surface so as to travel in the optical path of the first light in the opposite direction and detecting a position of the second reflected light;

an optical path movement mechanism moving at least one optical path of the optical path of the first light, the optical path of the first reflected light, the optical path of the second light, and the optical path of the second reflected light;

a control circuit controlling the optical path movement mechanism so that a first total sum of a plurality of intensity signals output from the first position detection sensor and a second total sum of a plurality of intensity signals output from the second position detection sensor change at the same time in a case in which the first and second lights and the stage are relatively moved to cross a boundary between two regions having different reflectances with respect to the first and second lights at a predetermined height position; and

a displacement measurement circuit calculating an average value of first displacement of the object surface based on the plurality of intensity signals output from the first position detection sensor and second displacement of the object surface based on the plurality of intensity signals output from the second position detection sensor to measure the average value as the displacement of the object surface.

According to another aspect of the present invention, a displacement measurement method includes:

allowing first light generated by a first light source to be incident to an object surface disposed on a stage from an oblique direction;

detecting a position of first reflected light by receiving the first reflected light of the first light reflected by the object surface using a first position detection sensor;

allowing second light generated by a second light source to be incident to the object surface from an oblique direction so as to travel in an optical path of the first reflected light in the opposite direction;

detecting a position of second reflected light by receiving the second reflected light of the second light reflected by the object surface so as to travel in the optical path of the first light in the opposite direction using a second position detection sensor;

moving at least one optical path of the optical path of the first light, the optical path of the first reflected light, the optical path of the second light, and the optical path of the second reflected light by using an optical path moving unit so that a first total sum of a plurality of intensity signals output from the first position detection sensor and a second total sum of a plurality of intensity signals output from the second position detection sensor change at the same time in a case in which the first and second lights and the stage are relatively moved to cross a boundary between two regions having different reflectances with respect to the first and second lights at a predetermined height position; and

calculating an average value of first displacement of the object surface based on the plurality of intensity signals output from the first position detection sensor and second displacement of the object surface based on the plurality of intensity signals output from the second position detection sensor to measure the average value as displacement of the object surface.

### BRIEF DESCRIPTION OF THE DRAWINGS

FIG. 1 is a configuration diagram illustrating a configuration of a displacement measurement device of Embodiment 1;

FIG. 2 is a diagram illustrating an optical lever type displacement measurement method of Embodiment 1;

FIGS. 3A to 3C are diagrams illustrating a method of correcting an erroneous recognition of a height change due to an influence of a difference in reflectance between patterns (dark and bright portions) of Embodiment 1;

FIG. 4 is a diagram illustrating an output of a position sensor of Embodiment 1;

FIG. 5 is a diagram showing a relationship between a total sum of an intensity signal and an unevenness of a measurement surface of Embodiment 1;

FIGS. 6A to 6C are diagrams illustrating a light collection effect of Embodiment 1;

FIG. 7 is a configuration diagram illustrating a configuration of a displacement measurement device of Embodiment 2; and

FIG. 8 is a configuration diagram illustrating a configuration of a displacement measurement device of Embodiment 3.

### DETAILED DESCRIPTION OF THE INVENTION

Here, an aspect of the embodiments provides a displacement measurement device and a displacement measurement method capable of suppressing or reducing an influence of a difference in reflectance between patterns by eliminating a difference between two beam spot positions when measuring height displacement of a substrate provided with patterns. Embodiment 1.

A displacement measurement device of Embodiment 1 can be used while being mounted on, for example, an electron beam inspection device. In the electron beam inspection device, there is a need to adjust a focus of multiple beams (or a single beam) when a substrate corresponding to an inspection object is irradiated with the beam. For this reason, in the inspection device, the height displacement of the substrate is measured by using the displacement measurement device. Then, the measured height displacement ΔZ of the substrate is used for an auto focus. However, the embodiments are not limited thereto. The displacement measurement device of Embodiment 1 may be used to measure height displacement of an object surface provided with patterns and can be mounted on an apparatus that requires information of the height displacement of the object surface provided with patterns.

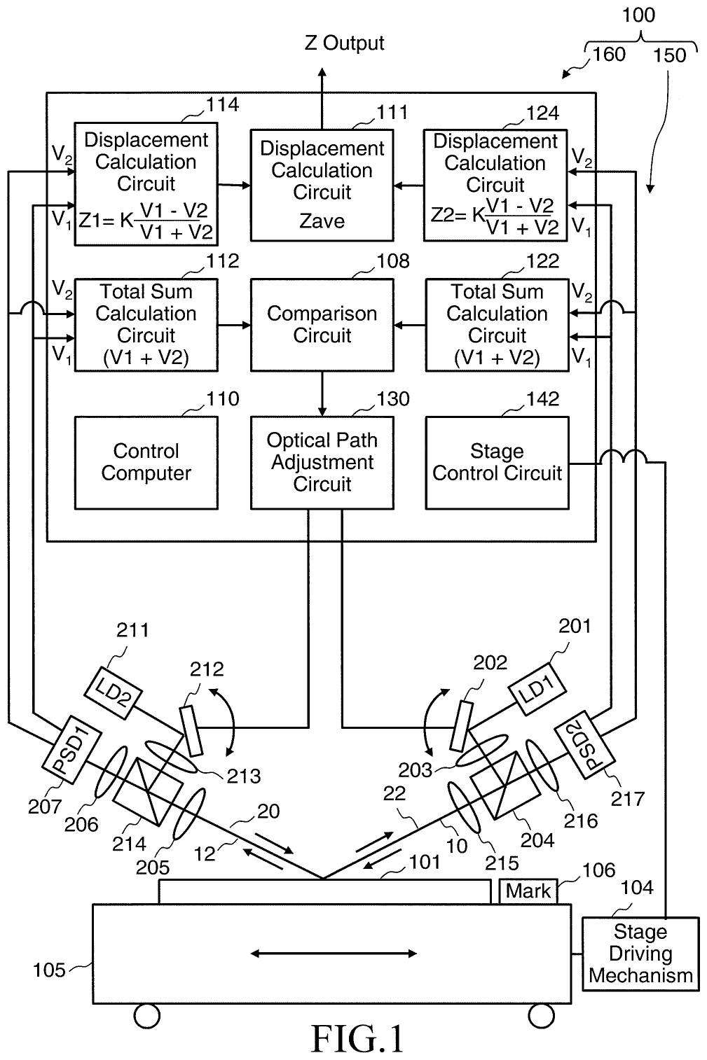

FIG. 1 is a configuration diagram illustrating a configuration of a displacement measurement device of Embodiment 1. In FIG. 1, a displacement measurement device 100 is an example of an optical lever type displacement measurement device. The displacement measurement device 100 includes a measurement mechanism 150 and a control system circuit 160. The measurement mechanism 150 includes a stage 105, a stage driving mechanism 104, and two sets of optical lever type displacement measurement mechanisms. The measurement mechanism 150 uses two optical lever type displacement measurement mechanisms and measures the height displacement at the same measurement position by disposing an optical system so that two beams travel in the same optical path in the opposite direction. The measurement mechanism 150 includes a light source 201, a mirror 202, a lens 203, a lens 206, and a sensor 207 as a first set of displacement measurement mechanisms, includes a light source 211, a mirror 212, a lens 213, a lens 216, and a sensor 217 as a second set of displacement measurement mechanisms, and includes a half mirror 204, a lens 205, a half mirror 214, and a lens 215 as a common optical system. As the light sources 201 and 211, for example, an LED or an optical fiber can be appropriately used. As the sensors 207 and 217, a position sensitive detector (PSD) sensor (an optical position sensor) can be appropriately used. Further, an angle adjustment mirror which changes an angle of an optical path is used as the mirrors 202 and 212 (an example of an optical path moving unit) of Embodiment 1.

A substrate 101 provided with a figure corresponding to an inspection object is disposed on the stage 105. The substrate 101 includes a semiconductor substrate such as an exposure mask or a silicon wafer. The substrate 101 is disposed on the stage 105, for example, so that a pattern forming surface faces upward. Further, a mark 106 is disposed on the stage 105. The mark 106 is disposed so that a height is adjustable and is generally adjusted to the same height as that of the inspection surface of the substrate 101.

In the control system circuit 160, a control computer 110 which controls the entire displacement measurement device 100 is connected to a comparison circuit 108, a displacement calculation circuit 111, a total sum calculation circuit 112, a displacement calculation circuit 114, a total sum calculation circuit 122, a displacement calculation circuit 124, an optical path adjustment circuit 130, and a stage control circuit 142 via a bus (not illustrated). Further, the stage 105 is driven by the stage driving mechanism 104 under the control of the stage control circuit 142. Further, the stage 105 is movable by a driving system such as a three-axis (X-Y-θ) motor driven in the X direction, the Y direction, and the θ direction. As these X, Y, and θ motors (not illustrated), for example, a stepping motor can be used. Further, the stage 105 is movable in the Z direction by using a Piezoelectric element and the like.

Light 10 (first light) generated by the light source 201 (the first light source) is reflected by the mirror 202 and is projected onto the half mirror 204 by the lens 203. Then, the light 10 projected onto the half mirror 204 is reflected by the half mirror 204, is collected by the lens 215, and is incident to the surface of the substrate 101 corresponding to an object of a measurement target from an oblique direction so as to have a predetermined spot diameter. The light 10 which is incident to the surface of the substrate 101 is reflected by the surface of the substrate 101. Reflected light 12 (first reflected light) of the light 10 reflected by the surface of the substrate 101 is projected onto the half mirror 214 by the lens 205. Then, the reflected light 12 passing through the half mirror 214 is collected by the lens 206 and is incident to the sensor 207. The sensor 207 (the first position detection sensor) receives the reflected light 12 and detects the position of the reflected light 12. An intensity signal which is detected by the sensor 207 is output to the total sum calculation circuit 112 and the displacement calculation circuit 114.

Meanwhile, light 20 (second light) generated by the light source 211 (the second light source) is reflected by the mirror 212 and is projected onto the half mirror 214 by the lens 213. Then, the light 20 projected onto the half mirror 214 is reflected by the half mirror 214, is collected by the lens 205, and is incident to the surface of the substrate 101 corresponding to an object of a measurement target from an oblique direction so as to have a predetermined spot diameter. The light 20 is incident to the surface of the substrate 101 from an oblique direction so as to travel in the optical path of the reflected light 12 in the opposite direction. The light 20 is incident to the same measurement position as that of the light 10. The light 20 which is incident to the surface of the substrate 101 is reflected by the surface of the substrate 101. Reflected light 22 (second reflected light) of the light 20 reflected by the surface of the substrate 101 is projected onto the half mirror 204 by the lens 215. Then, the reflected light 22 passing through the half mirror 204 is collected by the lens 216 and is incident to the sensor 217. The sensor 217 (the second position detection sensor) receives the reflected light 22 and detects the position of the reflected light 22. The sensor 217 receives the reflected light 22 reflected by the surface of the substrate 101 so that the light travels in the optical path of the light 10 in the opposite direction. The intensity signal detected by the sensor 217 is output to the total sum calculation circuit 122 and the displacement calculation circuit 124.

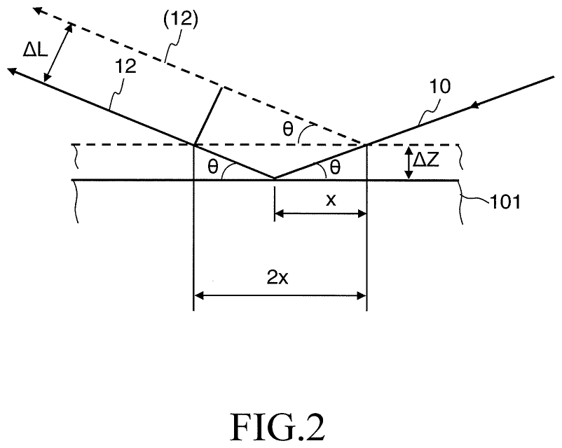

FIG. 2 is a diagram illustrating an optical lever type displacement measurement method of Embodiment 1. The substrate 101 corresponding to an inspection object cannot be defined such that a surface is a perfect flat surface. In many cases, the height position of the surface of the substrate 101 does not uniformly change in accordance with the unevenness of the surface, the bending of the substrate, and the vertical movement of the stage 105 when the stage travels. For this reason, the height displacement of the surface of the substrate 101 is measured by the displacement measurement device 100 while the stage 105 is moved. In FIG. 2, a description will be made by using the first set of displacement measurement mechanisms of two sets of optical lever type displacement measurement mechanisms. In FIG. 2, when the surface of the substrate 101 is irradiated with the light 10 from an oblique direction of an angle θ, the light 10 is reflected from the substrate 101 at an angle θ so that the reflected light 12 (solid line) is output. Here, in a case in which the surface of the substrate 101 is displaced by Δz in the height direction, the light 10 emitted from the same position hits the substrate 101 just before the displacement x from the previous time and is reflected from the substrate 101 at an angle θ so that the reflected light 12 (dotted line) is output. Thus, the optical axis (the center) of the reflected light is displaced by ΔL before and after the height position of the surface of the substrate 101 is displaced by Δz. Here, the displacement x can be defined by the following equation (1).

x=Δz/tan θ (1)

Further, a distance ΔL between the centers of the reflected lights can be defined by the following equation (2).

ΔL=2x·sin θ (2)

Thus, the distance ΔL between the centers can be transformed into the following equation (3).

ΔL=2·ΔZ/tan θ·sin θ (3)

Thus, the height displacement Z of the surface of the substrate 101 can be defined by the following equation (4).

ΔZ=ΔL·tan θ/(2·sin θ) (4)

Thus, it is possible to calculate (measure) the height displacement ΔZ (here, ΔZ1) by measuring the distance ΔL between the centers using the sensor 207 while the light incident angle θ is fixed in advance. Similarly, it is possible to calculate (measure) the height displacement ΔZ (here, ΔZ2) by measuring the distance ΔL between the centers using the sensor 217 while the light incident angle θ is fixed in advance.

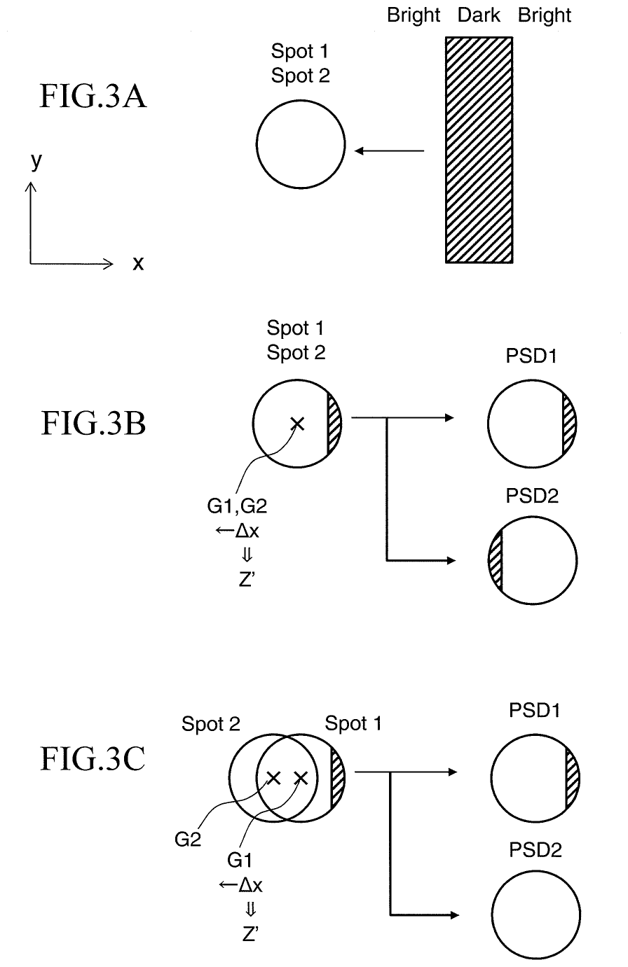

FIGS. 3A to 3C are diagrams for illustrating a method of correcting an erroneous recognition of a height change due to an influence of a difference in reflectance between the patterns (dark and bright portions) of Embodiment 1. As illustrated in FIG. 3A, a case in which a pattern crosses a spot 1 of the light 10 and a spot 2 of the light 20 incident to the substrate 101 with the movement of the stage 105 is supposed. An example of FIG. 3A illustrates a case in which a portion of a pattern 11 is a dark portion and a periphery thereof is a bright portion. The dark and bright portions may be reversed. Here, a description will be made such that a portion having small reflectance of light is a dark portion and a portion having large reflectance is a bright portion. In a case in which the positions of the spot 1 of the light 10 and the spot 2 of the light 20 are the same as each other, when the pattern 11 (the dark portion) overlaps a part of the spot with the movement of the stage 105 in the −x direction as illustrated in FIG. 3B, the intensity of the reflected light at the overlapping portion decreases and hence a center G is shifted from a spot center by Δx to the side opposite to the pattern 11 (the dark portion). As a result, since ΔL changes as illustrated in FIG. 2, there is an erroneous recognition as if the height displacement occurs in the first set of optical lever type displacement measurement mechanisms. In Embodiment 1, since two sets of optical lever type displacement measurement mechanisms traveling in the same optical path in the opposite direction are used, for example, when the pattern 11 (the dark portion) overlaps a part of the spot from the right side of the drawing, the light receiving intensity at the right portion of the drawing overlapping the pattern 11 (the dark portion) in the sensor 207 (PSD1) decreases.

Meanwhile, since the optical path of the sensor 217 (PSD2) is opposite, the light receiving intensity at the left portion at the opposite side decreases instead of the right portion of the drawing overlapping the pattern 11 (the dark portion). Thus, the height position displacement ΔZ1 using the sensor 207 (PSD1) is measured as ΔZ1 =ΔZ0 +z′ such that an error z′ is added to an original height displacement ΔZ0. Meanwhile, since the error z′ is detected in the opposite direction in the height displacement ΔZ2 using the sensor 217 (PSD2), ΔZ2=ΔZ0−z′ is measured. Thus, when an average value ΔZave of them is calculated, an error is cancelled and a measurement of ΔZave=ΔZ0 can be performed. However, in a case in which the spot 1 of the light 10 and the spot 2 of the light 20 deviate from each other due to a manufacturing error or an optical system adjustment failure, the pattern 11 (the dark portion) partially overlaps the spot 1, but the pattern 11 (the dark portion) does not overlap the spot 2 or an overlapping state is different from that of the spot 1 as illustrated in FIG. 3C. For this reason, the height displacement ΔZ1 using the sensor 207 (PSD1) is measured as ΔZ1=ΔZ0+z′ such that the error z′ is added to the original height displacement ΔZ0, but in the height displacement ΔZ2 using the sensor 217 (PSD2), an equation of ΔZ2=ΔZ0 is obtained and hence an error cannot be cancelled even when an average is obtained by using ΔZ1 and ΔZ2. Thus, the position of the spot 1 of the light 10 and the position of the spot 2 of the light 20 incident to the surface of the substrate 101 may not essentially match each other in order to measure the height displacement without the influence of the pattern. However, it is not easy to manually adjust the optical system so that the position of the spot 1 of the light 10 matches the position of the spot 2 of the light 20. Here, in Embodiment 1, an angle adjustment mirror is used as the mirrors 202 and 212 to automatically adjust the angle of the optical path so that the spot positions match each other. Further, for this reason, the intensity signals corresponding to the outputs of the sensors 207 and 217 are used.

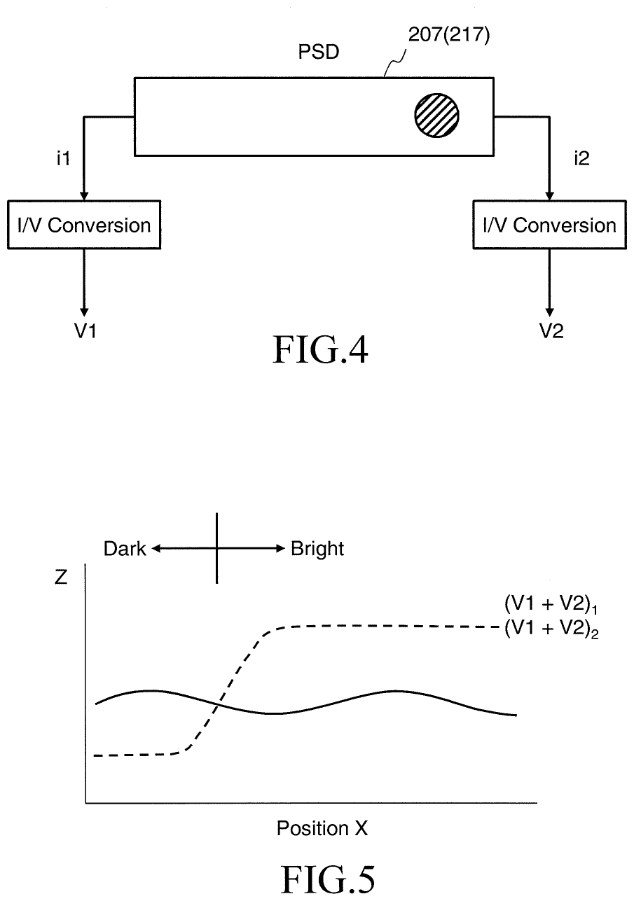

FIG. 4 is a diagram illustrating an output of a position sensor of Embodiment 1. In the sensor 207 (217), when the reflected light 12 (22) is received, currents i1 and i2 defined by a resistance corresponding to a distance from a light receiving position to an end portion flow to both ends of a sensor substrate. The light receiving position becomes the center position of the light. Then, the current it flowing to one end portion is converted into a voltage V1 and the voltage V1 is output as the intensity signal. Similarly, the current i2 flowing to the other end portion is converted into a voltage V2 and the voltage V2 is output as the intensity signal. By using two intensity signals V1 and V2 output from both ends, the height displacement Z can be calculated by the following equation (5). k is a coefficient. The equation (5) becomes a modified equation of the equation (4)

ΔZ=k·(V1−V2)/(V1+V2) (5)

FIG. 5 is a diagram showing a relationship between a total sum of the intensity signal and an unevenness of a measurement surface of Embodiment 1. The height position Z is displaced by the unevenness of the surface of the substrate 101. The values of the intensity signal V1 and the intensity signal V2 change when the height position Z is displaced. Meanwhile, the total sum (V1+V2) of two intensity signals V1 and V2 is not changed even when the height position Z is changed by the unevenness of the surface of the substrate 101. The total sum (V1+V2) of two intensity signals V1 and V2 change when the light intensity (light amount) is changed due to the overlapping of a part of the spot of the incident light with respect to the pattern on the substrate 101 with the movement of the stage 105. This is similarly true for the total sum (V1+V2) 1 of two intensity signals V1 and V2 output from the sensor 207 and the total sum (V1+V2) 2 of two intensity signals V1 and V2 output from the sensor 217. Thus, when the pattern on the substrate 101 enters the spot of the incident light as a result of monitoring the total sum (V1+V2) 1 of two intensity signals V1 and V2 output from the sensor 207 and the total sum (V1+V2) 2 of two intensity signals V1 and V2 output from the sensor 217, it can be determined that the spot 1 and the spot 2 match each other when the total sum values change at the same time. Here, in Embodiment 1, the spot 1 and the spot 2 are allowed to match each other by using such a method.

First, the spot 1 of the incident light 10 and the spot 2 of the incident light 20 of the displacement measurement device 100 are set to substantially match each other on the surface of the substrate 101. When the components of the displacement measurement device 100 are disposed according to a design dimension, the spot 1 and the spot 2 ideally match each other. However, there is actually a difference between both spots.

As a first light incident step, the light 10 generated by the light source 201 is incident to the surface of the substrate 101 (an example of the object surface) disposed on the stage 105 from an oblique direction. Then, as a first detection step, the reflected light 12 of the light 10 reflected by the surface of the substrate 101 is received by the sensor 207 so that the position of the reflected light 12 is detected.

At the same time, as a second light incident step, the light 20 generated by the light source 211 is incident to the surface of the substrate 101 (an example of the object surface) from an oblique direction so as to travel in the optical path of the reflected light 12 in the opposite direction. Then, as a second detection step, the reflected light 22 of the light 20 reflected by the surface of the substrate 101 is received by the sensor 217 so as to travel in the optical path of the light 10 in the opposite direction so that the position of the reflected light 22 is detected.

As a stage movement step, the stage 105 is moved so that the mark 106 is located at the spot positions of the incident lights 10 and 20 of the displacement measurement device 100. A line pattern extending in the x direction and a line pattern extending in the y direction are formed on the mark 106.

For example, a cross pattern obtained by crossing both line patterns is disposed. In addition, the height of the mark 106 is adjusted to the same height as that of the surface of the substrate 101. In other words, the spot 1 and the spot 2 ideally match each other on the surface of the mark 106. However, there is actually a difference between both spots.

Alternatively, the stage 105 may be moved first so that the mark 106 is located at the spot positions of the incident lights 10 and 20 and as a first light incident step, the light 10 generated by the light source 201 may be incident to the mark 106 (another example of the object surface) disposed on the stage 105 from an oblique direction. Then, as a first detection step, the reflected light 12 of the light 10 reflected by the mark 106 is received by the sensor 207 so that the position of the reflected light 12 is detected. In such a case, at the same time, as a second light incident step, the light 20 generated by the light source 211 is incident to the mark 106 (another example of the object surface) from an oblique direction so as to travel in the optical path of the reflected light 12 in the opposite direction. Then, as a second detection step, the reflected light 22 of the light 20 reflected by the mark 106 is received by the sensor 217 so as to travel in the optical path of the light 10 in the opposite direction so that the position of the reflected light 22 is detected.

The intensity signal V1 and the intensity signal V2 of the sensor 207 detected on the surface of the mark 106 are output to the total sum calculation circuit 112 and the displacement calculation circuit 114. As a first total sum calculation step, the total sum calculation circuit 112 in these circuits calculates the total sum (V1+V2) 1 of two intensity signals V1 and V2 output from the sensor 207. The calculated total sum (V1+V2) 1 is output to the comparison circuit 108.

Similarly, the intensity signal V1 and the intensity signal V2 of the sensor 217 detected on the surface of the mark 106 are output to the total sum calculation circuit 122 and the displacement calculation circuit 124. As a second total sum calculation step, the total sum calculation circuit 122 in these circuits calculates the total sum (V1+V2) 2 of two intensity signals V1 and V2 output from the sensor 217. The calculated total sum (V1+V2) 2 is output to the comparison circuit 108.

In such a state, the lights 10 and 20 and the stage 105 are relatively moved to cross a boundary between two regions having different reflectances with respect to the lights 10 and 20 at the height position (predetermined height position) of the surface of the mark 106. Specifically, the stage 105 is continuously moved in, for example, the x direction. In accordance with the movement of the stage, the line pattern formed on the mark 106 to extend in the y direction enters the spot 1 of the light 10 and the spot 2 of the light 20. During the movement of the stage, the reflected lights 12 and 22 are continuously detected by the sensors 207 and 217. The total sum calculation circuit 112 continuously calculates the total sum (V1+V2) 1 of two intensity signals V1 and V2 output from the sensor 207. For example, the total sum (V1+V2) 1 of the intensity signals V1 and V2 is calculated at a predetermined sampling cycle (for example, 10 ms to 1 s). The calculated total sum (V1+V2) 1 is output to the comparison circuit 108.

Similarly, the total sum calculation circuit 122 is synchronized with the total sum calculation circuit 112 to continuously calculate the total sum (V1+V2) 2 of two intensity signals V1 and V2 output from the sensor 217. For example, the total sum (V1+V2) 2 of the intensity signals V1 and V2 is calculated at a predetermined sampling cycle (for example, 10 ms to 1 s). The calculated total sum (V1+V2) 2 is output to the comparison circuit 108.

As a comparison step, the total sum (V1+V2) 1 and the total sum (V1+V2) 2 are compared with each other in the comparison circuit 108. For example, a difference between the total sum (V1+V2) 1 and the total sum (V1+V2) 2 is calculated at a predetermined sampling cycle (for example, 10 ms to 1 s). When the spot 1 and the spot 2 match each other, a difference between the total sum (V1+V2) 1 and the total sum (V1+V2) 2 is always zero. When the spot 1 and the spot 2 deviate from each other, a difference between the total sum (V1+V2) 1 and the total sum (V1+V2) 2 always has a finite value other than zero. The calculated difference between the total sum (V1+V2) 1 and the total sum (V1+V2) 2 is output to the optical path adjustment circuit 130.

The optical path adjustment circuit 130 (an example of the control circuit) can move the optical path of the light 10 by controlling the mirror 202 and variably changing the reflection surface. Since the optical path of the light 10 moves, the optical path of the reflected light 12 can also move. Similarly, the optical path adjustment circuit 130 can move the optical path of the light 20 by controlling the mirror 212 and variably changing the reflection surface. Since the optical path of the light 20 moves, the optical path of the reflected light 22 can also move.

Here, in a case in which the lights 10 and 20 and the stage 105 are relatively moved to cross a boundary between two regions having different reflectances with respect to the lights 10 and 20 on the surface of the mark 106 (a predetermined height position) as an optical path adjustment step, at least one optical path of the optical path of the light 10, the optical path of the reflected light 12, the optical path of the light 20, and the optical path of the reflected light 22 is moved by using the mirror 202 and/or the mirror 212 (an example of the optical path moving unit) controlled by the optical path adjustment circuit 130 so that the total sum (V1+V2) 1 of two intensity signals V1 and V2 (a plurality of intensity signals) output from the sensor 207 and the total sum (V1+V2) 2 of two intensity signals V1 and V2 (a plurality of intensity signals) output from the sensor 217 change at the same time. In a case in which such an optical path adjustment is not completed by one movement operation of the stage 105, the movement operation of the stage 105 may be repeated until the total sum (V1+V2) 1 and the total sum (V1+V2) 2 change at the same time.

With the above-described configuration, it is possible to eliminate the deviation of the spot positions of the two beams.

As a stage movement step, the stage 105 is moved so that the initial measurement position of the substrate 101 of the measurement target is located at the spot positions of the incident lights 10 and 20 of the displacement measurement device 100. The height displacement of the substrate 101 is measured from such a state.

As a first light incident step, the light 10 generated by the light source 201 is incident to the surface of the substrate 101 (an example of the object surface) disposed on the stage 105 from an oblique direction. Then, as a first detection step, the reflected light 12 of the light 10 reflected by the surface of the substrate 101 is received by the sensor 207 so that the position of the reflected light 12 is detected. The detected intensity signal V1 and the intensity signal V2 of the sensor 207 are output to the total sum calculation circuit 112 and the displacement calculation circuit 114. As a first displacement calculation step, the displacement calculation circuit 114 of these circuits calculates the height displacement ΔZ1 (the first displacement) of the surface of the substrate 101 based on two intensity signals V1 and V2 output from the sensor 207. The height displacement ΔZ1 may be calculated by using the equation (5). Accordingly, it is possible to measure the height displacement ΔZ1 of the surface of the substrate 101 based on the detection of the sensor 207. The calculated height displacement ΔZ1 (the first displacement) is output to the displacement calculation circuit 111.

At the same time, as a second light incident step, the light 20 generated by the light source 211 is incident to the surface of the substrate 101 (an example of the object surface) from an oblique direction so as to travel in the optical path of the reflected light 12 in the opposite direction. Then, as a second detection step, the reflected light 22 of the light 20 reflected by the surface of the substrate 101 so as to travel in the optical path of the light 10 in the opposite direction is received by the sensor 217 so that the position of the reflected light 22 is detected. The detected intensity signal V1 and the intensity signal V2 of the sensor 217 are output to the total sum calculation circuit 122 and the displacement calculation circuit 124. As a second displacement calculation step, the displacement calculation circuit 124 of these circuits calculates the height displacement ΔZ2 (the second displacement) of the surface of the substrate 101 based on two intensity signals V1 and V2 output from the sensor 217. The height displacement ΔZ2 may be calculated by using the equation (5). Accordingly, it is possible to measure the height displacement ΔZ2 of the surface of the substrate 101 based on the detection of the sensor 217. The calculated height displacement ΔZ2 (the second displacement) is output to the displacement calculation circuit 111.

As a displacement measurement step, the displacement calculation circuit 111 (the displacement measurement circuit) calculates an average value of the height displacement ΔZ1 (the first displacement) of the substrate 101 (the object surface) based on the plurality of intensity signals output from the sensor 207 and the height displacement ΔZ2 (the second displacement) of the substrate 101 (the object surface) based on the plurality of intensity signals output from the sensor 217 to measure the average value as the true height displacement ΔZave of the surface of the substrate 101. The measured height displacement ΔZave is output.

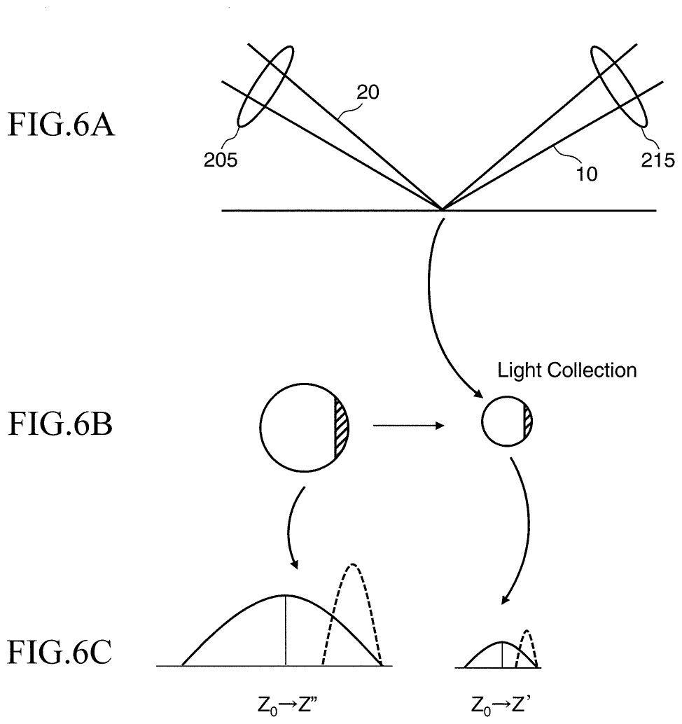

FIGS. 6A to 6C are diagrams illustrating a light collection effect of Embodiment 1. As illustrated in FIG. 6A, in Embodiment 1, the light 10 is collected by the lens 215 and is emitted onto the substrate 101 while the spot diameter is decreased. Similarly, the light 20 is collected by the lens 205 and is emitted onto the substrate 101 while the spot diameter is decreased. Accordingly, as illustrated in FIG. 6B, when the pattern crosses the spot, the light amount which is attenuated by the pattern is small in a configuration having a small spot diameter as compared with a configuration having a large spot diameter as illustrated in FIG. 6C. Thus, it is possible to reduce a strength (light amount) error caused by the pattern in the configuration having a small spot diameter as compared with the configuration having a large spot diameter. As a result, the height displacement error can be also decreased from z″ to z′.

Here, in the above-described example, a case in which the optical path is adjusted so that the positions of the spot 1 and the spot 2 match each other by using the mark 106 has been described, but the embodiments are not limited thereto. It is also appropriate to adjust the optical path so that the positions of the spot 1 and the spot 2 match each other by using the pattern formed on the substrate 101 corresponding to the measurement target.

As described above, according to Embodiment 1, in a case in which the height displacement ΔZave of the substrate 101 provided with the pattern is measured, it is possible to suppress or reduce an influence of a difference in reflectance between the patterns by eliminating a difference between two beam spot positions.

### Embodiment 2

In Embodiment 1, a case in which the optical path is adjusted by the angle adjustment mirror is shown, but the embodiments are not limited thereto. In Embodiment 2, the case of adjusting the optical path by another configuration will be described.

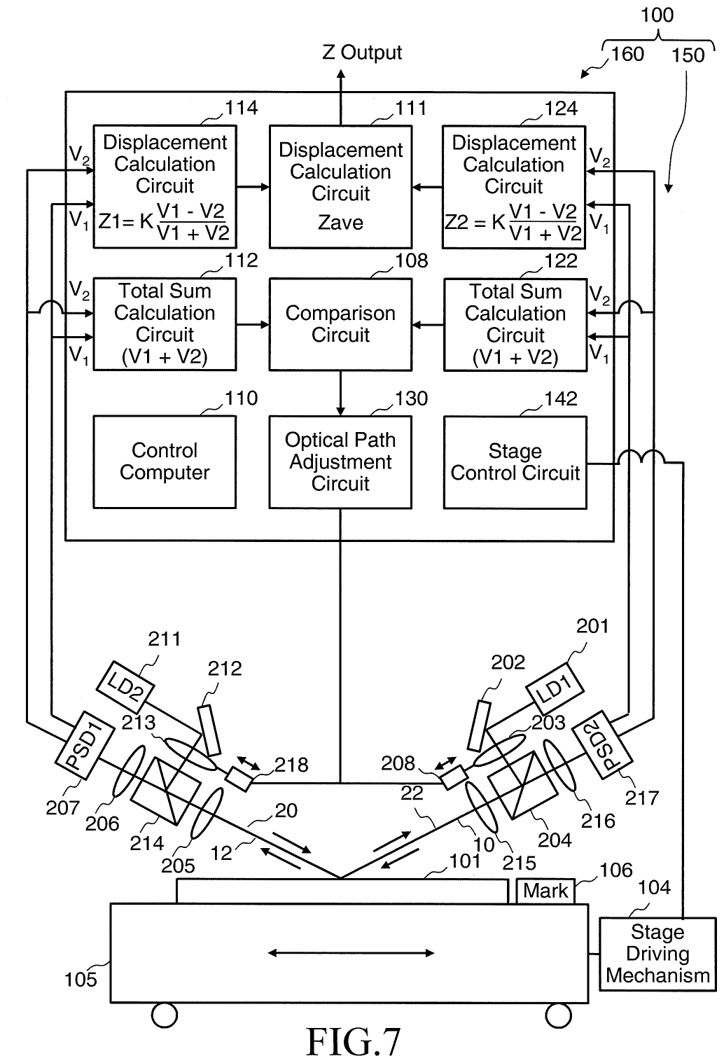

FIG. 7 is a configuration diagram illustrating a configuration of a displacement measurement device of Embodiment 2. The displacement measurement device 100 of FIG. 7 is the same as that of FIG. 1 except that lens driving mechanisms 208 and 218 are disposed and the mirrors 202 and 212 are changed from an angle adjustment mirror to a fixed mirror. Hereinafter, contents other than those specifically described are the same as those in Embodiment 1.

In Embodiment 2, a shift adjustment lens which shifts an optical path is used as another example of the optical path moving unit instead of the angle adjustment mirror. The shift adjustment lens of the first set of displacement measurement mechanism is configured by a combination of the lens 203 and the lens driving mechanism 208. When the position of the lens 203 is moved by the lens driving mechanism 208, the optical path of the light 10 passing through the lens 203 is shifted. Similarly, the shift adjustment lens of the second set of displacement measurement mechanism is configured by a combination of the lens 213 and the lens driving mechanism 218. When the position of the lens 213 is moved by the lens driving mechanism 218, the optical path of the light 20 passing through the lens 213 is shifted. The lens driving mechanisms 208 and 218 are controlled by the optical path adjustment circuit 130.

In a case in which the lights 10 and 20 and the stage 105 are relatively moved to cross a boundary between two regions having different reflectances with respect to the lights 10 and 20 on the surface of the mark 106 (a predetermined height position) as an optical path adjustment step, at least one optical path of the optical path of the light 10, the optical path of the reflected light 12, the optical path of the light 20, and the optical path of the reflected light 22 is moved by using the shift adjustment lens obtained by the combination of the lens 203 and the lens driving mechanism 208 and/or the shift adjustment lens obtained by the combination of the lens 213 and the lens driving mechanism 218 controlled by the optical path adjustment circuit 130 (an example of the optical path moving unit) so that the total sum (V1+V2) 1 of two intensity signals V1 and V2 (the plurality of intensity signals) output from the sensor 207 and the total sum (V1+V2) 2 of two intensity signals V1 and V2 (the plurality of intensity signals) output from the sensor 217 change at the same time. In a case in which such an optical path adjustment is not completed by one movement operation of the stage 105, the movement operation of the stage 105 may be repeated until the total sum (V1+V2) 1 and the total sum (V1+V2) 2 change at the same time.

As described above, according to Embodiment 2, when at least one optical path of the optical path of the light 10, the optical path of the reflected light 12, the optical path of the light 20, and the optical path of the reflected light 22 is moved by the shift adjustment lens, the positions of the spot 1 and the spot 2 can match each other. Thus, it is possible to exhibit the same effect as that of Embodiment 1.

### Embodiment 3.

A case in which the optical path is adjusted by using the angle adjustment mirror has been described in Embodiment 1 and a case in which the optical path is adjusted by the shift adjustment lens has been described in Embodiment 2, but the embodiments are not limited thereto. In Embodiment 3, a case in which the optical path is adjusted by another configuration will be described.

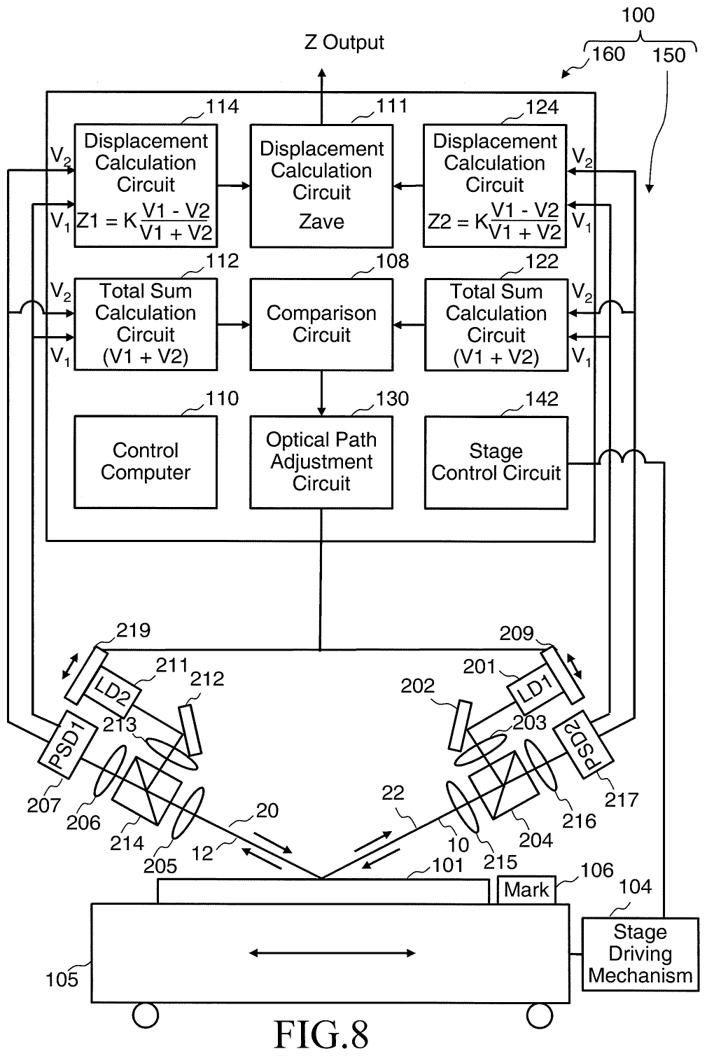

FIG. 8 is a configuration diagram illustrating a configuration of a displacement measurement device of Embodiment 3. The displacement measurement device 100 of FIG. 8 is different from that of FIG. 1 in that shift stages 209 and 219 are disposed and the mirrors 202 and 212 are changed from an angle adjustment mirror to a fixed mirror. Hereinafter, contents other than those specifically described are the same as those in Embodiment 1.

In Embodiment 3, the shift stages 209 and 219 which shift one of the light sources 201 and 211 are used as another example of the optical path moving unit instead of the angle adjustment mirror. By moving the position of the light source 201 and/or the light source 211, the optical path of generated light is shifted. In the first set of displacement measurement mechanisms, the light source 201 is disposed on the shift stage 209. By moving the shift stage 209, the position of the light source 201 is shifted and the optical path of the light 10 generated from the light source 201 is shifted.

Similarly, in the second set of displacement measurement mechanisms, the light source 211 is disposed on the shift stage 219. By moving the shift stage 219, the position of the light source 211 is shifted and the optical path of the light 20 generated from the light source 211 is shifted. The shift stages 209 and 219 are controlled by the optical path adjustment circuit 130.

In a case in which the lights 10 and 20 and the stage 105 are relatively moved to cross a boundary between two regions having different reflectances with respect to the lights 10 and 20 on the surface of the mark 106 (a predetermined height position) as an optical path adjustment step, at least one optical path of the optical path of the light 10, the optical path of the reflected light 12, the optical path of the light 20, and the optical path of the reflected light 22 is moved by using the shift stage 209 and/or the shift stage 219 (an example of the optical path moving unit) controlled by the optical path adjustment circuit 130 so that the total sum (V1+V2) 1 of two intensity signals V1 and V2 (the plurality of intensity signals) output from the sensor 207 and the total sum (V1+V2) 2 of two intensity signals V1 and V2 (the plurality of intensity signals) output from the sensor 217 change at the same time. In a case in which such an optical path adjustment is not completed by one movement operation of the stage 105, the movement operation of the stage 105 may be repeated until the total sum (V1+V2) 1 and the total sum (V1+V2) 2 change at the same time.

As described above, according to Embodiment 3, when at least one optical path of the optical path of the light 10, the optical path of the reflected light 12, the optical path of the light 20, and the optical path of the reflected light 22 is moved by the shift stages 209 and 219, the positions of the spot 1 and the spot 2 can be allowed to match each other. Thus, it is possible to exhibit the same effect as that of Embodiment 1.

In the description above, a series of “circuits” include a processing circuit and this processing circuit includes an electric circuit, a computer, a processor, a circuit board, a quantum circuit, a semiconductor device, or the like. Further, a common processing circuit (same processing circuit) may be used for each “circuit”. Alternatively, a different processing circuit (another processing circuit) may be used. A program for executing a processor or the like may be recorded on a recording medium such as a magnetic disk device, a magnetic tape device, an FD, or a ROM (read only memory) (not illustrated). For example, the comparison circuit 108, the displacement calculation circuit 111, the total sum calculation circuit 112, the displacement calculation circuit 114, the total sum calculation circuit 122, the displacement calculation circuit 124, the optical path adjustment circuit 130, and the stage control circuit 142 may be configured as at least one processing circuit of the above-described examples. For example, these circuits may be configured as a computer or a processor inside the control computer 110.

As described above, embodiments have been described with reference to the detailed examples. However, the embodiments are not limited to these detailed examples. In the above-described embodiments, an inspection device using multiple beams generated by electron beams has been described as an inspection device equipped with a displacement measurement device, but the embodiments are not limited thereto. The embodiments can be also applied to other inspection devices. Further, the above-described displacement measurement device is not limited to one mounted on the inspection device and may be mounted on other devices. Alternatively, the displacement measurement device may be used alone. Anyway, the displacement measurement device of the above-described embodiment can be employed as long as the displacement measurement device is of an optical lever type that measures the displacement of the target object in the height direction by emitting light to the surface of the target object provided with patterns from an oblique direction and receiving the reflected light from the target object surface.

Further, a description of parts and the like which are not directly necessary for describing the embodiments, such as a device configuration and a control method, are omitted, but necessary device configuration and control method can be appropriately selected and used.

In addition, all displacement measurement devices and the displacement measurement methods which include the components of the embodiments and can be appropriately designed and changed by those skilled in the art are included in the scope of the embodiments.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A displacement measurement device comprising:
a movable stage having an object of a measurement target disposed thereon;
a first light source generating first light incident from an oblique direction to an object surface;
a first position detection sensor receiving first reflected light of the first light reflected by the object surface and detecting a position of the first reflected light;
a second light source generating second light incident from an oblique direction to the object surface so that the second light travels in an optical path of the first reflected light in the opposite direction;
a second position detection sensor receiving second reflected light of the second light reflected by the object surface so as to travel in the optical path of the first light in the opposite direction and detecting a position of the second reflected light;
an optical path movement mechanism moving at least one optical path of the optical path of the first light, the optical path of the first reflected light, the optical path of the second light, and the optical path of the second reflected light;
a control circuit controlling the optical path movement mechanism so that a first total sum of a plurality of intensity signals output from the first position detection sensor and a second total sum of a plurality of intensity signals output from the second position detection sensor change at the same time in a case in which the first and second lights and the stage are relatively moved to cross a boundary between two regions having different reflectances with respect to the first and second lights at a predetermined height position; and
a displacement measurement circuit calculating an average value of first displacement of the object surface based on the plurality of intensity signals output from the first position detection sensor and second displacement of the object surface based on the plurality of intensity signals output from the second position detection sensor to measure the average value as the displacement of the object surface.

2. The device according to claim 1,
wherein an angle adjustment mirror changing an angle of an optical path is used as the optical path movement mechanism.

3. The device according to claim 1,
wherein a shift adjustment lens shifting an optical path is used as the optical path movement mechanism.

4. The device according to claim 1,
wherein a shift stage shifting one of the first and second light sources is used as the optical path movement mechanism.

5. The device according to claim 1, further comprising:
a first total sum calculation circuit calculating the first sum of the plurality of intensity signals output from the first position detection sensor.

6. The device according to claim 5, further comprising:
a second total sum calculation circuit calculating the second total sum of the plurality of intensity signals output from the second position detection sensor separately from the first total sum calculation circuit.

7. The device according to claim 1, further comprising:
a first displacement calculation circuit calculating the first displacement of the object surface based on the plurality of intensity signals output from the first position detection sensor.

8. The device according to claim 7, further comprising:
a second displacement calculation circuit calculating the second displacement of the object surface based on the plurality of intensity signals output from the second position detection sensor separately from the first displacement calculation circuit.

9. The device according to claim 1, further comprising:
a comparison circuit comparing the first total sum with the second total sum and outputting a comparison result to the control circuit.

10. A displacement measurement method comprising:
allowing first light generated by a first light source to be incident to an object surface disposed on a stage from an oblique direction;
detecting a position of first reflected light by receiving the first reflected light of the first light reflected by the object surface using a first position detection sensor;
allowing second light generated by a second light source to be incident to the object surface from an oblique direction so as to travel in an optical path of the first reflected light in the opposite direction;
detecting a position of second reflected light by receiving the second reflected light of the second light reflected by the object surface so as to travel in the optical path of the first light in the opposite direction using a second position detection sensor;
moving at least one optical path of the optical path of the first light, the optical path of the first reflected light, the optical path of the second light, and the optical path of the second reflected light by using an optical path moving unit so that a first total sum of a plurality of intensity signals output from the first position detection sensor and a second total sum of a plurality of intensity signals output from the second position detection sensor change at the same time in a case in which the first and second lights and the stage are relatively moved to cross a boundary between two regions having different reflectances with respect to the first and second lights at a predetermined height position; and
calculating an average value of first displacement of the object surface based on the plurality of intensity signals output from the first position detection sensor and second displacement of the object surface based on the plurality of intensity signals output from the second position detection sensor to measure the average value as displacement of the object surface.
